(19) United States
(12) Patent Application Publication
(10) Pub. No.: US 2026/0121554 A1
(43) Pub. Date: Apr. 30, 2026

(54) METHOD FOR CONTROLLING A BATTERY CHARGE OF A POLYPHASE ELECTRICAL SYSTEM FOR GENERATING A DC VOLTAGE BY SWITCHING THE CURRENT LINES

(71) Applicants: STELLANTIS AUTO SAS, Poissy (FR); CENTRALESUPELEC, GIF-SUR-YVETTE (FR); CENTRE NATIONAL DE LA RECHERCHE SCIENTIFIQUE, PARIS cedex 16 (FR); SAFT, LEVALLOIS PERRET (FR); SORBONNE UNIVERSITE, PARIS (FR); UNIVERSITE PARIS-SACLAY, GIF-SUR-YVETTE (FR)

(72) Inventors: FRANCIS ROY, LES ULIS (FR); Dominique OSWALD, Bruges (FR); Thomas PEUCHANT, Le Bouscat (FR); David HERPE, Tresses (FR); ANAS LAHLOU, Bordeaux (FR); Claude MARCHAND, PALAISEAU (FR); Eric LABOURE, CACHAN (FR)

(21) Appl. No.: 19/483,109

(22) PCT Filed: Apr. 11, 2024
(86) PCT No.: PCT/FR2024/050475

§ 371 Date: Nov. 10, 2025

(30) Foreign Application Priority Data
May 30, 2023 (FR) FR2305326

(51) Int. Cl. H02M 7/797; B60L 53/22; H02J 3/08; H02J 7/06; H02M 1/00; H02M 1/084

(52) U.S. Cl. CPC H02M 7/797; B60L 53/22; H02J 3/08; H02J 7/06; H02M 1/007; H02M 1/0085; H02M 1/084

(57) ABSTRACT

The present invention relates to a method for controlling a polyphase electrical system comprising a battery with a distributed multilevel inverter, the method comprising at least one charging configuration of the battery (BAT) comprising the following simultaneously controlled steps of generating a first DC voltage at the output of a diode module (RD) from one current line (LT1) among the three lines (LT1, LT2, LT3) during which the elementary modules (MCLk) of the line (LT1) are controlled as a function of a first reference setpoint, and charging with AC voltage the cells (CLK) of the elementary modules (MCLk) of the two other current lines (LT2, LT3) among the three lines (LT1, LT2, LT3) during which the elementary modules (MCLk) of the two other lines (LT2, LT3) are controlled as a function of a second reference setpoint synchronized with an AC voltage of an extended power supply network (RES). The invention applies to electrified vehicles and to stationary storage systems.

### CROSS REFERENCE TO RELATED APPLICATIONS

This application is the US National Stage under 35 USC § 371 of International App. No. PCT/FR2024/050475 filed Apr. 11, 2024 which claims the priority of French application No. 2305326 filed on May 30, 2023, the content (text, drawings and claims) of both said applications being incorporated by reference herein.

### BACKGROUND

This application relates to a method for controlling a polyphase electrical system for generating a DC electrical network during single-phase recharging of a battery.

Electrified vehicles feature a high-power traction battery, typically operating in the voltage range 260 volts to 450 volts. When charging a vehicle with single-phase current, an AC/DC converter converts the alternating electric current into battery-compatible direct current, and a DC/DC converter transforms this DC voltage into another, lower voltage suitable for the on-board network, usually around 12 volts. It is therefore possible to generate on-board network voltage while the vehicle is being charged.

The applicant has developed a so-called distributed multilevel inverter breakthrough architecture that dispenses with the voltage converters usually integrated between an electrochemical cell battery and the AC power supply network. This architecture has been the subject of several patent applications by the applicant. Examples include documents WO-A1-2017/153366 and WO-A1-2021/048477. They describe a cell architecture comprising current lines formed by elementary modules, each comprising an electrochemical cell, or a cluster of cells, and a switching module forming an H-bridge. These documents further describe innovative control methods for this architecture, enabling cells to be balanced in terms of state of charge, and polyphase or direct current to be generated.

Generating the DC voltage for the on-board network during AC vehicle charging is problematic for this architecture, as it is necessary to activate the DC voltage generation by driving the multilevel inverter distributed in the battery, and then produce the DC current for the on-board network via a DC/DC converter. To solve this problem of DC voltage generation while the vehicle is recharging on an AC network, the applicant has come up with a solution consisting of injecting a common-mode voltage on all three current lines. This solution is described in patent FR-A1-3121797.

However, this solution is not suitable for single-phase charging. As the three battery current lines are connected serially, it is not possible to generate the common-mode voltage.

### SUMMARY

There is therefore a need to remedy the above-mentioned problems. One aim is to propose a single-phase AC charging protocol for a vehicle equipped with a battery with a distributed multilevel inverter architecture, enabling the vehicle's on-board network voltage to be maintained during charging.

More precisely, a method is disclosed for controlling a polyphase electrical system for recharging an electrochemical cell power battery of said system, the battery comprising three current lines in which each line comprises a plurality of serially-connected elementary modules, each provided with a cell or cluster of cells and a switching module comprising an H-bridge, forming a multilevel inverter distributed in the battery capable of generating a selected voltage waveform across each current line.

The method comprises at least one battery charging configuration comprising the following steps controlled simultaneously:
generating a first DC voltage at the output of a diode module from one current line of said three lines, during which the elementary modules of said line are controlled as a function of a first reference setpoint,
charging the cells of the elementary modules of the other two of the three current lines using AC voltage, during which the elementary modules of said other two lines are controlled according to a second reference setpoint synchronized with an AC voltage of an extended power supply network.

The method may comprise the following additional features, alone or in combination:
Successively ordering, in a loop, first, second and third battery charging configurations, wherein in the first charging configuration, a first DC voltage is generated from a first current line, and the cells are charged with an AC voltage using the second and third current lines; wherein in the second configuration, the first DC voltage is generated from the second current line, and the cells are charged with an AC voltage using the first and third current lines; and wherein in the third configuration, the first DC voltage is generated from the third current line, and the cells are charged using the first and second current lines.
The following steps prior to the controlling of one of said first, second and third charging configurations: a step of monitoring an electrical parameter representative of the maximum controllable value of the voltage wave of at least one of said current lines comprising detecting whether the parameter is below a threshold, and in case of detecting that said parameter is below said threshold, the control of a fourth charging configuration comprising the AC voltage charging of the cells of the elementary modules of the first, second and third current lines simultaneously.
The fourth charging configuration further comprises connecting the first, second and third current lines in series to a single phase branch of the electrical system for AC voltage charging.
The voltage threshold is equal to the maximum value of the extended supply voltage waveform.
During cell charging for the first, second and third charging configurations, the on-load current lines are connected in parallel to a single-phase AC power supply interface.
During the generation of the first DC voltage, the conversion of the first DC voltage into a second DC voltage so as to recharge a service battery of a DC voltage electrical network.

A polyphase electrical system is also provided, comprising an electrochemical cell power battery, three phase branches for recharging the battery from an extended AC power supply network, and a diode module electrically connected to said phase branches by three branch circuits, the battery comprising three current lines, each line comprising a plurality of elementary modules connected in series, each provided with a cell or cluster of cells and a switching module) comprising an H-bridge, forming a distributed multilevel inverter in the battery capable of generating a selected voltage waveform across each current line, and comprising a control unit configured to implement any of the embodiments of the control method.

In one variant, the system comprises a power supply interface for a single-phase AC electrical charging, and a coupling device for electrically connecting the three phase branches in parallel to the power supply interface.

An electrified motor vehicle comprising such an electrical system is also provided.

A stationary storage system comprising such an electrical system is also provided.

Additionally, a computer program is disclosed comprising instructions which, when the program is executed by a control unit of a battery of a polyphase electrical system, cause the latter to implement any one of the embodiments of the control method.

The method has the advantage that it can be implemented by a software-only solution for controlling the polyphase electrical system. The method enables DC voltage to be generated for an electrical network simultaneously with single-phase cell charging.

### DESCRIPTION OF THE FIGURES

Other features and advantages of the claimed invention will become clearer on reading the following detailed description comprising embodiments of the claimed invention given by way of non-limiting examples and shown by the appended drawings, wherein:

FIG. 1 shows an example of a polyphase system comprising a battery equipped with a multilevel inverter and designed to implement the control method.

FIG. 2 shows an embodiment of the system comprising a diode module for generating a DC voltage bus for a battery-powered DC voltage electrical network.

FIG. 3 shows an electrical system charging configuration that generates DC voltage and charges the other two battery current lines from single-phase AC current.

FIG. 4 shows an example of the control method.

FIG. 5 shows a single-phase voltage waveform used for the load line reference setpoint during the method.

FIG. 6 schematically shows an embodiment of the electrical system for an electrified vehicle.

### DETAILED DESCRIPTION

A polyphase electrical system is disclosed for the energy storage system for electrified motor vehicles and stationary storage systems in electrical installations, e.g. for renewable energy or network regulation installations. The polyphase system comprises an electrochemical battery comprising elementary cell modules interconnected to form a distributed multilevel inverter structure in the battery, allowing the battery to be connected to an electrical system operating with DC voltage and also with AC voltage without the intermediary of an inverter. The battery system can be connected directly to an extended power supply network and an electric drive machine. The purpose of the system is to provide a control method for maintaining the DC network voltage supplied by the power battery during single-phase AC charging. In particular, the method aims to maintain the voltage of an electrified vehicle's on-board network while the vehicle is being recharged.

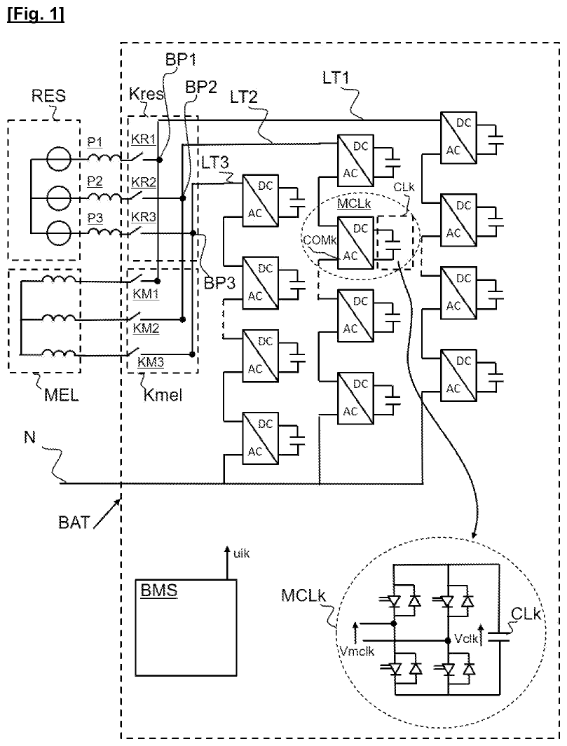

In the present description, the term “distributed multilevel inverter” is understood to mean that the current line or each current line of the battery, in the case of a polyphase, in particular three-phase, architecture, is formed by a plurality of serially-connected elementary modules, and each elementary module comprises a cell or a cluster of cells, as well as a switching module forming an H-bridge, the control unit comprises a means of controlling the elementary modules of the current line based on a reference setpoint and is able to generate a selected AC voltage waveform on each current line. This architecture is described in greater detail in FIG. 1.

Referring to FIG. 1, the power battery BAT comprises a plurality n of elementary modules MCLk forming the distributed multilevel inverter structure in the battery and comprises three current lines LT1, LT2 and LT3 connected to phase branches BP1, BP2, and BP3 wherein the elementary modules MCLk are arranged. The elementary modules MCLk are connected serially in each current line. The phase branches BP1, BP2 and BP3 connect the battery to various systems designed to use AC or DC voltage. In this three-phase configuration, each current line comprises n/3 elementary modules.

The battery system BAT has a terminal voltage of several hundred volts, for example 350 volts or 1000 volts. At 350 volts, each line LT1, LT2, LT3 is equipped, for example, with 24 elementary cell modules or cell clusters connected in series. However, depending on electrical requirements, the battery system BAT may have a nominal voltage of only several tens of volts (e.g. 24 V, 36 V, 48 V), particularly for automotive applications, or a maximum voltage of 1500 Volts DC or even higher, particularly for stationary storage systems.

In a first set of phase branch circuits BP1, BP2 and BP3, the battery system BAT comprises high-voltage switches Kres, also known as high-voltage contactors, for electrically connecting the battery BAT to an extended power supply network RES. Each current line LT1, LT2 and LT3 is connected on one side, via these branches to a network connection switch, KR1, KR2 and KR3, respectively, and on the other side to a neutral terminal N of the battery. The extended power supply network RES operates on 50 Hz or 60 Hz AC voltage and comprises a three-phase line with three voltage lines P1, P2 and P3. The battery system BAT is adapted to generate three waves of three-phase voltages offset by 2TT/3. The control of each current line is similar, differing only by an offset of 2TT/3 between them.

It is worth noting that, thanks to this multilevel inverter architecture distributed in the battery, the electrical system does not include an AC/DC voltage converter between the LT1, LT2 and LT3 power lines and the phase branches BP1, BP2 and BP3 operating on alternating current.

Furthermore, in an embodiment for an electrified vehicle, the battery system BAT is the vehicle's traction battery and further comprises Kmel high-voltage switches for electrically connecting the battery BAT to an electric drive machine MEL. Each current line LT1, LT2 and LT3 is connected, via a second set of phase branch circuits BP1, BP2, BP3, on one side to a connection switch of the electric machine, KM1, KM2 and KM3, respectively, and on the other side to a neutral terminal N of the battery. The electric drive machine can be an asynchronous or synchronous machine, or even a DC machine, as the battery system is capable of generating any voltage waveform, AC or DC.

Alternatively, for one embodiment of a renewable energy installation, the second set of phase branch circuits can be connected to a photovoltaic or wind power installation. Alternatively, the battery is connected to the power supply network for network regulation purposes.

A further set of branch circuits is provided to connect the battery to a DC voltage bus. This part will be described in more detail in the following figures, which describe the control method for maintaining the voltage of a DC voltage network during single-phase AC battery recharging.

The battery system BAT further comprises a control unit BMS, one of whose functions is to control the voltage waveform of each line LT1, LT2, LT3 based on a reference setpoint Vref from the elementary modules MCLk. Each elementary module MCLk may comprise a single cell CLK, or a cluster of cells CLK that may be two, three, four, five, six or more cells in number, forming the elementary voltage Vclk. The elementary module MCLk further comprises a switching module COMk able to configure the elementary module MCLk in three different states to deliver the voltage Vmclk which is respectively said elementary voltage Volk, a zero voltage and the inverted voltage Vclk to said connection terminals of the module MCLK.

The switching module COMk, for example, comprises two switching parts forming an H-bridge that can be controlled in three different states by a control signal from the control unit BMS of the battery BAT specifically addressing the module MCLk. The states are represented by a control variable uik which, for example, can take on the values 1, 0, ×1 representing the three different states respectively controlling said elementary voltage Vclk, a zero voltage and said inverted voltage −Vclk at said connection terminals of the elementary module k addressed by the control signal uik. Each switching module COMk comprises electronic components, such as power transistors, possibly of the MOSFET or HEMT (High Electron Mobility Transistor) type, driven by control signals from the control unit BMS. In this way, the voltage Vmclk at the terminals of each elementary module MCLk among the totality n of modules can be controlled based on a control signal uik according to the following relationship:

$${u}_{i k} = \{ \begin{matrix}1 & if {V}_{ref \_ i} ( t ) > {n}_{k} \cdot {V}_{clk} \\ - 1 & if {V}_{ref \_ i} ( t ) < - {n}_{k} \cdot {V}_{Clk} \\ 0 & else\end{matrix} \qquad Equation 1$$

Thus, on each voltage line LT1, LT2 and LT3, the control unit BMS can control any voltage waveform formed in amplitude steps equal to the elementary voltage Vclk based on a reference voltage setpoint Vref by connecting the cells serially by means of switching modules COMk. The reference voltage setpoint Vref can be sinusoidal with a frequency of 50 Hz, any alternating form, e.g. square waveform, or can be a constant voltage, for example.

An electrochemical cell is an electrical energy accumulator with two terminals, a positive and a negative electrode, and a voltage of a few volts, usually between 2.3 V and 4.2 V. The cells can be of the Lithium-ion type (lithium nickel manganese cobalt oxides NMC or lithium iron phosphate LFP can be cited as examples of positive electrode active materials), nickel cadmium (Ni—Cd), nickel-metal-hydride (Ni-MH) for example. More specifically, a Lithium-ion cell is comprised mainly of a porous positive electrode, a porous negative electrode, a separator and an electrolyte (which may be liquid, polymeric, or solid). The operating principle of a lithium-ion cell is based on the reversible exchange of lithium ions between the two porous electrodes.

In FIG. 2, the battery system BAT is shown schematically within the polyphase electrical system. For the sake of clarity, the set branch circuits for the electric drive machine is no longer shown.

The polyphase electrical system comprises a third set of phase branch circuits PB1, PB2 and PB3 for connecting the battery BAT to a BDC DC voltage bus. This set of branch circuits comprises three branch circuits D1, D2 and D3 connected respectively to the phase branches BP1, BP2 and BP3. The branch circuits D1, D2 and D3 are connected to a diode module RD comprising three diodes d1, d2 and d3 connected to branch circuits D1, D2 and D3 respectively. In addition, switches K6, K7 and K8 are provided to selectively connect and disconnect diodes d1, d2 and d3 to and from their respective branch circuits D1, D2 and D3. At the output of the diode module RD, the three diodes d1, d2 and d3 are connected to a DC voltage bus BDC. The DC voltage bus BDC is adapted to power at least one DC voltage system. It supplies power to one or more items of equipment from a set of equipment comprising one or more DC/DC voltage converters, an electric compressor, an electric heater, for example in an electrified vehicle application. Other electrical systems are also possible, depending on the application.

The function of the diode module RD is to generate a first DC voltage Vdc whose shape and amplitude can be adjusted by driving the generated voltage waveforms Vlt1, Vlt2 and Vlt3 on current lines LT1, LT2 and LT3 respectively. The first DC voltage Vdc is equal to the maximum voltage amplitude controlled among the three connected current lines LT1, LT2 and LT3. The three lines LT1, LT2 and LT3 can be connected to the diode module to generate the voltage Vdc or one line only. For example, Vdc can be generated from line LT1 only, and lines LT2 and LT3 are disconnected. Vdc can be generated from line LT2 only, and lines LT1 and LT3 are disconnected. Vdc can be generated from line LT3 only, and lines LT1 and LT2 are disconnected.

The diode module RD is made up of standard components that are easy to obtain and install. Furthermore, diodes have the advantage of being reliable, robust and low-cost.

This example further comprises a DC/DC voltage converter CONV connected to the output of the diode module RD, designed to convert the voltage Vdc into a second, lower-level voltage Vrdb, e.g. 12 volts. Other values are possible depending on the application, ranging from 12 volts to 450 volts. This converter CONV supplies a DC voltage network RDB when the converter is supplied with Vdc voltage. In addition, the DC voltage network RDB comprises a service battery BAT2 to stabilize the network voltage RDB and ensure the electrical needs of the network RDB when the converter CONV is not supplying it, in particular when the power battery is being charged from a single-phase current.

In addition, the polyphase system comprises switches K4 and K5 arranged to selectively connect current lines LT1, LT2 and LT3 in series and parallel, thus enabling single-phase and three-phase battery operation. Specifically, in single-phase configuration, the switches KR2, KR3 and K5 are open, and the switches KR1 and K4 are closed. Thus, the current lines LT1, LT2 and LT3 are serially connected to the phase branch BP1 connected to the extended power supply network RES. In three-phase configuration, the switch K4 is open and the switches KR1, KR2, KR3 and K5 are closed. Thus, the current lines LT1, LT2 and LT3 are connected respectively to phase branches BP1, BP2 and BP3 connected to the extended power supply network RES.

In addition, the polyphase system comprises a power interface PR adapted to electrically connect the phase branches BP1, BP2 and BP3 to a single-phase power line. Typically, the PR power interface can be a power socket, power cable or any power interface means comprising a coupling device arranged to connect the three phase branches BP1, BP2 and BP3 in parallel to the single-phase AC power line.

It should also be noted that the voltage Vdc is adjustable in amplitude depending on the operating configuration of the power battery BAT. In three-phase AC charging mode, the voltage Vdc can be generated simultaneously with charging by injecting a common-mode voltage to the three current lines LT1, LT2 and LT3. This operating mode is the subject of French patent application FR-A1-3121797 by the applicant.

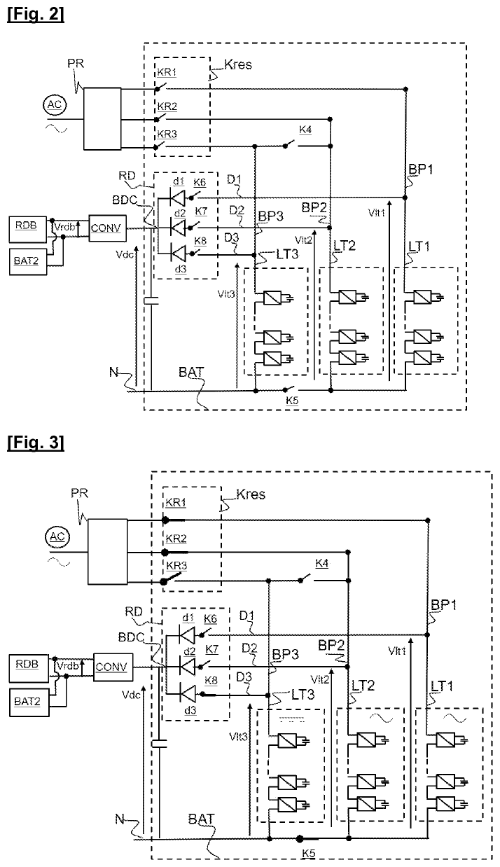

FIG. 3 shows a charging configuration for the polyphase system, enabling the battery BAT to be recharged from a single-phase alternating current simultaneously with the generating of a DC voltage Vdc at the output of the diode module RD. In this configuration, the two phase branches BP1, BP2 are connected in parallel to a single-phase supply line of the power supply network. The switches KR1 and KR2 are closed. The phase branch BP3 is disconnected from the AC supply network, KR3 is open. The switches K6 and K7 are also open. The line LT3 only is used to generate the DC voltage bus BDC at the output of the diode module RD. K8 is closed.

Furthermore, a method for controlling the battery BAT comprises the controlling of a plurality of charging configurations, including at least one charging configuration, during which the method comprises the generating of the DC voltage Vdc by a DC voltage formed by the cells of one of the current lines, the voltage Vlt3 of the line LT3 as shown in FIG. 3. To this end, the cells of the line LT3 are controlled as a function of a continuous reference setpoint Vref3 with a value between 100 volts and 450 volts. The cells of the other two current lines, LT1 and LT2 in FIG. 3, are each controlled as a function of a reference setpoint synchronized with the AC voltage of the single-phase supply network. In this way, the control method enables single-phase electrical recharging to take place simultaneously with the generation of the DC voltage Vdc bus.

For this three-current-line battery configuration, the control method can therefore control three charging configurations CR1, CR2 and CR3. In the first charging configuration, the first DC voltage Vdc is generated from the first current line LT1 and AC voltage charging of the cells is operated from the second LT2 and third LT3 current lines; in the second configuration CR2 the first DC voltage Vdc is generated from the second current line LT2 and the AC voltage charging of the cells is operated from the first LT1 and third LT3 current lines; and in the third configuration CR3 the first DC voltage is generated from the third current line LT3 and the AC voltage charging of the cells is operated from the first LT1 and second LT2 current lines.

Furthermore, in order to maintain cell charge balancing between the lines LT1, LT2 and LT3, the control method comprises the controlling of these three charge configurations CR1, CR2 and CR3, controlled successively and in a loop during the charging of the battery BAT. These charging configurations are swapped according to a selected period ranging from a few minutes to several tens of minutes. The period is constant for all three configurations.

A monitoring function is also provided to check that each current line LT1, LT2 and LT3 of the battery BAT is capable of generating a voltage amplitude sufficient for connection to the AC power supply network. Indeed, in the event of a major battery discharge, due to the reduction in cell voltage resulting from a low charge level, it is possible that the maximum voltage of one of the lines may not reach the peak voltage of the network, thus preventing synchronization with the network.

To solve this problem, the monitoring function is configured during initialization of a battery charge to detect whether the maximum controllable value of the voltage wave of at least one of the current lines LT1, LT2 and LT3 is below a voltage threshold. The voltage threshold depends on the voltage of the supply network, and can be between 150 volts and 350 volts depending on the network standard (120 volts or 230 volts).

The monitoring function further comprises controlling a fourth charging configuration CR4 dependent on the result of this detection and comprising the AC voltage charging of the cells of current lines LT1, LT2, LT3 simultaneously, during which the lines are serially connected. To implement this fourth charging configuration CR4, with reference to FIG. 2, the network switch KR1 is closed and switches KR2 and KR3 are open. The switch K4 is closed and switch K5 is open. Switches K6, K7 and K8 are opened to disconnect the diode module RD. The electrical requirements of the DC voltage network RDB are temporarily met by the service battery BAT2, which delivers the voltage Vrdb until the voltage of each line returns to above the voltage threshold.

In FIG. 4, the control method is described in the form of a block diagram and shows the charging configuration switching sequence controlled by the control unit.

The method comprises an initialization step E0 prior to the battery charging sequence from a single-phase AC mains line. The storage system is not yet connected to the network. The initialization step E0 comprises starting up the battery and the control unit.

In addition, the initialization step E0 can provide for precharging of a voltage bus capacitor BDC to avoid a current spike phenomenon when one of switches K6, K7 and K8 is closed.

In addition, before each closing of switches KR1, KR2 and K3, the control method includes a step for synchronizing the voltage waves generated by the battery current lines with the AC power supply network. More specifically, synchronization involves controlling the phase alignment and the voltage-amplitude difference between a battery current line and the network which is below a threshold (expressed in voltage), for example a few volts. The synchronization of a line is takes place each time the charging configuration is switched.

Firstly, the control method includes a step E1 of monitoring an electrical parameter representative of the maximum controllable value of the voltage wave Vltx of at least one of the current lines LT1, LT2 and LT3, or each current line. This monitoring step E1 comprises detecting whether said parameter is below a voltage threshold S1, for example 310 volts. The maximum controllable value corresponds to the sum of the voltages of all the cells in a current line connected in series. This value can be measured at any time by the battery control unit using voltage sensors in each cell or cell cluster. Alternatively, the electrical parameter is an estimate of the state of charge of the cells in each line, and the threshold S1 is a value representative of the state of charge. S1 can then be expressed in points (%) of state-of-charge capacity or in ampere-hours.

If it is detected that one of the current lines has a maximum controllable voltage value which is below said threshold S1, the method controls the fourth charging configuration CR4 comprising a step of AC voltage charging ECH4 of the cells of the elementary modules MCLk of the first, second and third current lines LT1, LT2, LT3 simultaneously. During the charging ECH4, the three current lines LT1, LT2 and LT3 are serially connected.

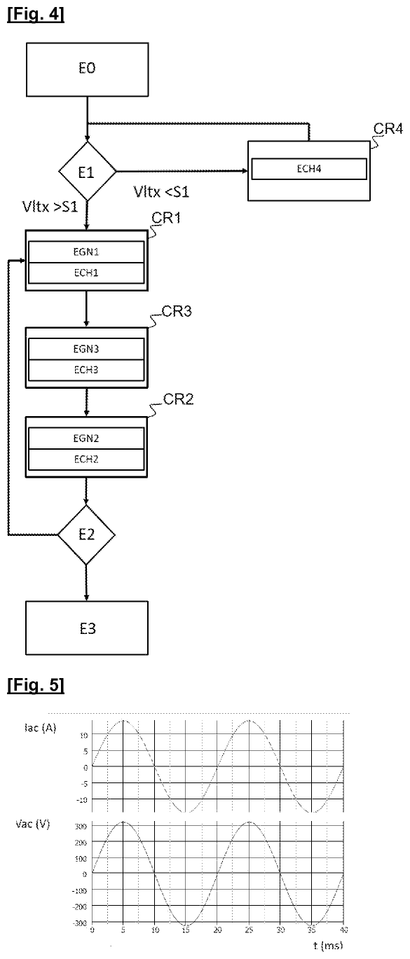

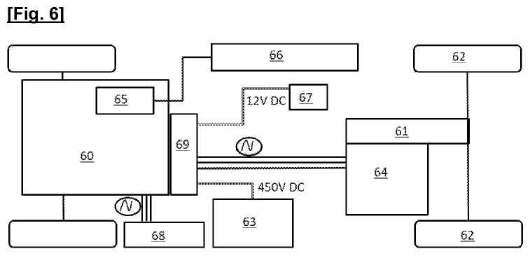

FIG. 5 shows the single-phase AC voltage generated on the phase branch of the battery system during the charging ECH4 from the serially-connected cells of the three serially-configured current lines LT1, LT2 and LT3. The lower curve represents the voltage Vac generated at the battery terminals, expressed in volts, and the upper curve represents the current lac from the supply network, expressed in amperes. The advantage of this configuration is that a peak voltage can be generated using all the elementary modules of the three current lines. This configuration enables cells to be recharged when the battery's state of charge is low, e.g. for states of charge below 10% of total charge.

If it is detected that each of the current lines has a maximum controllable voltage value which is greater than said threshold S1, the method orders one of the charging configurations, for example the first charging configuration CR1. Alternatively, the method can trigger the second charging configuration CR2 or the third charging configuration CR3.

The first charging configuration CR1 comprises the following steps, controlled simultaneously, of the generating EGN1 of the first DC voltage Vdc at the output of the diode module from the current line LT1 during which the elementary modules of said first line are controlled as a function of a first reference setpoint Vref1, and of the AC voltage charging ECH1 of the cells of the elementary modules of the other two current lines LT2, LT3, during which the elementary modules of said other two lines are controlled according to a second reference setpoint Vref2 synchronized with an AC voltage of the extended power supply network. With reference to FIG. 5, the voltages Vlt2 and Vlt3 for lines LT2 and LT3 respectively are generated identically to the Vac curve.

More specifically, the first Vrefl setpoint is a DC voltage signal with a value of between 100 volts and 450 volts. The setpoint Vref2 is a signal measured from the single-phase AC power supply interface. The same signal Vref2 is used to synchronize the two current lines LT2 and LT3 to be charged.

The first charging configuration CR1 is controlled for a period P.

Once this period P has elapsed, the control method comprises switching the charging configuration. The switch comprises controlling the stopping of the charging of the cells on the line LT3, then generating a DC voltage on the line LT3 in accordance with the first setpoint Vref1, then stopping the generating of the DC voltage on the line LT1, then synchronizing the voltage Vlt1 with the AC mains voltage, and finally connecting the current line LT1 to the AC network.

Once the configuration switch is complete, the method orders the third charging configuration CR3 for the duration of period P. During this period, the method orders the generating EGN3 of the first DC voltage Vdc at the output of the diode module from the current line LT3, during which the elementary modules of the line LT3 are controlled according to the DC voltage setpoint, and the AC voltage charging ECH3 of the cells of the elementary modules of the other two current lines LT1, LT2, during which the elementary modules are controlled according to the reference setpoint Vref2 synchronized with the AC voltage of the extended power supply network.

Once this period P has elapsed, the control method comprises a new charging configuration switch to enable the configuration CR2. The switch comprises controlling the stopping of the charging of the cells on the line LT2, then generating a DC voltage on the line LT2 in accordance with the first setpoint Vref1, then stopping the generating of the DC voltage on the line LT3, then synchronizing the voltage Vlt3 with the AC mains voltage, and finally connecting the current line LT3 to the AC network. Once the configuration switch is complete, the method orders the second configuration CR2 for the duration of period P, and then orders a new charging configuration swap and orders the first configuration CR1.

It should be noted that the three charging configurations follow each other in a loop to ensure cell balancing. At the end of each loop, the method comprises a step E2 of monitoring an end-of-charge condition, which comprises, for example, detecting whether the value of an electrical parameter, such as the voltage of a cell or set of cells or the state of charge, reaches an end-of-charge threshold S2. The end-of-charge condition can be the detection of an end-of-charge request.

If an end of charge is detected, the method switches to the charge exit state E3.

It should be noted that switching of charging configurations CR1, CR2 and CR3 do not necessarily involve opening and closing the switches K6, K7 and K8, due to the presence of precharge capacity. Preferably, the switches remain closed throughout the control method.

FIG. 5 shows the application of the electrical system for an electrified vehicle with all-electric or hybrid drive. The vehicle comprises an electric drive machine 64 capable of transmitting torque to the vehicle's drive wheels 62 via a transmission 61. The electric machine 64 may be a three-phase machine. The vehicle comprises an electrical system comprising the battery 60 according to the distributed multilevel inverter architecture in the battery as described in FIG. 1. The battery comprises three current lines that can generate three-phase and single-phase voltage waveforms. The vehicle further comprises an interface for recharging the battery 68 from a supply network operating on AC voltage. The recharging interface 68 is a recharging box electrically connecting the terminals of the battery 60 to the terminal for AC voltage recharging with three-phase and single-phase current. The recharging interface 68 is also suitable for fast DC voltage recharging. The battery system 60 is advantageous in that its control unit 65 adapts the voltage waveform in AC or DC waveform without the need for a voltage converter. The vehicle further comprises a supervisory system 66 cooperating with the control unit 65 of the battery system 60. The battery system 60 can be directly electrically connected to the electric drive machine 64, thus improving its traction energy efficiency.

The battery can also be connected to a high-voltage DC bus, for example operating at a nominal voltage of between 100 and 800 volts, e.g. 450 volts, and to a low-voltage on-board network 67 operating at a nominal voltage of 12 volts. To this end, the electrical system comprises power electronics 69 comprising a diode module electrically connected to the battery current lines. The diode module comprises at least three diodes as shown in FIG. 2. The output of the diode module supplies the 450-volt voltage bus, for example. In addition, the power electronics 69 comprise a DC/DC converter connecting the voltage bus to the on-board network 67 (450 volts/12 volts) comprising a service battery. The electrical system is controlled so that the service battery supplies said DC network in the first phase of the method, and the converter converts the DC bus voltage (450 volts) to low voltage (12 volts) to supply the on-board network and charge the service battery in the second phase of the method.

In another embodiment, a stationary storage system comprising the electrical system as described above is envisaged.

The disclosed system and method is described in the foregoing by way of example. It is understood that the person skilled in the art is capable of carrying out different variants of the disclosed system and method by combining, for example, the various features hereinbefore, taken either alone or in combination, without thereby departing from the scope of the claimed invention.

1. A method for controlling a polyphase electrical system for recharging an electrochemical-cell power battery of said system, the battery comprising three current lines in which each line comprises a plurality of serially-connected elementary modules, each provided with a cell or cell cluster and a switching module comprising an H-bridge, forming a distributed multilevel inverter in the battery capable of generating a selected voltage waveform at the terminals of each current line, the method comprising at least one configuration for charging the battery comprising the following steps operated simultaneously:
generating a first DC voltage at the output of a diode module from one current line of said three lines, during which the elementary modules of said one current line are controlled as a function of a first reference setpoint,
the AC voltage charging of the cells of the elementary modules of the two other current lines among the three lines during which the elementary modules of said two other lines are controlled as a function of a second reference setpoint synchronized with an AC voltage of an extended power supply network.

2. The method according to claim 1 comprising successively ordering, in a loop, first, second and third charging configurations of the battery:
the first charging configuration during which the first DC voltage is generated from a first current line and the AC voltage charging of the cells is operated for second and third current lines,
the second configuration during which the first DC voltage is generated from the second current line and the AC voltage charging of the cells is operated for the first and third current lines, and
the third configuration during which the first DC voltage is generated from the third current line and the charging of the cells is operated for the first and third current lines.

3. The method according to claim 2, further comprising the following steps prior to controlling one of said first, second and third charging configurations:
a step of monitoring an electrical parameter representative of the maximum controllable value of the voltage wave of at least one of said current lines, comprising detecting whether the parameter is below a threshold,
and if it is detected that said parameter is below said threshold, controlling a fourth charging configuration comprising AC voltage charging of the cells of the elementary modules of the first, second and third current lines simultaneously.

4. The method according to claim 3 wherein the fourth charging configuration further comprises the serial connecting of the first, second and third current lines to a single phase branch of the electrical system for AC voltage charging.

5. The method according to claim 3, wherein the voltage threshold is equal to the maximum value of the waveform of the voltage of the extended power supply network.

6. The method according to claim 2 in which, during the charging of the cells for the first, second and third charging configurations, the on-load current lines are connected in parallel to a single-phase AC power supply interface.

7. The method according to claim 1, further comprising, during the generating of the first DC voltage, converting the first DC voltage into a second DC voltage so as to recharge a service battery of a DC voltage electrical network.

8. A polyphase electrical system comprising a power battery with electrochemical cells, three phase branches for recharging the battery from an extended AC power supply network, and a diode module electrically connected to said phase branches by three branch circuits, the battery comprising three current lines, each line comprising a plurality of elementary modules connected in series, each elementary module provided with a cell or cluster of cells and a switching module comprising an H-bridge, forming a distributed multilevel inverter in the battery capable of generating a selected voltage waveform across each current line, characterized in that it comprises a control unit configured to implement the control method according to claim 1.

9. The system according to claim 8, comprising a power supply interface for single-phase AC electrical charging, and a coupling device for electrically connecting the three phase branches in parallel to the power supply interface.

10. An electrified motor vehicle comprising an electrical system according to claim 8.

11. A stationary storage system comprising an electrical system according to claim 8.
